(19) United States
(12) Patent Application Publication
(10) Pub. No.: US 2002/0063167 A1
(43) Pub. Date: May 30, 2002

(54) Rotary drive for a hydraulic tool

(75) Inventor: Christian Stoffers, Rheda-Wiedenbruck (DE)

Correspondence Address: Barnes & Thornburg, 750 17th Street, N.W., 9th Floor, Washington, DC, 20006, US

(73) Assignee: Hammelmann Maschinenfabrik GmbH

(21) Appl. No.: 09/994,070

(22) Filed: Nov. 27, 2001

(30) Foreign Application Priority Data
Nov. 30, 2000 (DE) 200 20 281.2

(51) Int. Cl. B05B 3/06

(52) U.S. Cl. 239/252; 239/259

(57) ABSTRACT

A rotary drive for a hydraulic tool includes a housing; a hydraulic connection on the housing; and a rotatable hollow shaft in the housing, having an axially extending center passage duct and being connected with a nozzle carrier. A sleeve is inserted from a hydraulic connection end of the housing into the passage duct. A seal consisting of at least one separate ring seal rests in a sealing manner on the wall of the passage duct and on the sleeve. A device exerts pressure on the seal.

### BACKGROUND AND SUMMARY INVENTION

The present invention relates to a rotary drive for a hydraulic tool.

A rotary drive for a hydraulic tool, for example, a nozzle head, is shown in German Patent Document DE 38 12 132 A1, corresponding to U.S. Pat. No. 4,923,120, as well as German Patent Document DE 92 16 438 U1,corresponding to U.S. Pat. No. 5,402,936.

In the first document, the hydraulic connection is a fixed component of the housing, so that no access is possible from this end to the passage duct of the hollow shaft. For sealing off the sleeve with respect to the duct into which the sleeve is inserted, the sleeve's surface area is such that, in an interaction with the wall of the passage duct in the overlapping area, a labyrinth gap seal is created. The labyrinth gap seal requires a corresponding length of the sleeve, in order to achieve a reasonably sufficient sealing effect.

A sealing is also implemented in this manner in German Patent Document DE 92 16 438 U1. The labyrinth gap seal does not interact directly with the wall of the passage duct but with an other sleeve. The other sleeve which, on the end, specifically on the end situated opposite the hydraulic connection, is inserted into the hollow shaft and encloses in a contacting manner a large surface area of the sleeve.

In addition to the length of the sealing surface required for a labyrinth gap seal, which length naturally requires a corresponding dimensioning of the sleeve and is therefore disadvantageous with respect to the manufacturing, a labyrinth gap seal is not absolutely tight, so that leaking water occurs which must be discharged and removed.

Particularly when such a rotary drive is operated at higher pressures (>2,000 bar), the leaking water will warm up to above 60° C. This results in a precipitation of calcium and clogs the leakage openings. As a result, the seals, for example, bearing seals, are worn out so that leaking water on the outside on the hollow shaft can reach the interior of the rotary drive. If this rotary drive is an electric drive, as illustrated and described in German Patent Document DE 92 16 438 U1, the leaking water will penetrate into the rotor area of the rotary drive and will lead to its total failure.

It is therefore an object of the invention to construct a rotary drive of the above-mentioned type such that it can be produced in a simpler and more cost effective manner and its service life can be significantly increased.

This object is achieved by a rotary drive of the present invention, wherein the seal between a sleeve, which extends from a hydraulic connection end of the drive, and a rotatable hollow shaft having a passage consists of at least one separate ring seal which rests in a sealing manner on the wall of the passage duct and on the sleeve.

As a result of this constructive measure, a number of advantages are achieved.

First, the sleeve can be dimensioned to be relatively short, which permits lower manufacturing tolerances and reduces the manufacturing costs.

Since, as a result of the invention, no more leaking water will form and or leak out which, as mentioned above, heats up at high pressures with the corresponding consequences, the service life of the rotary drive is significantly increased.

The leakage lines, which are well known, can definitely be provided as previously. They will, however, only carry out controlling or relieving functions so that, in the event that a leakage should occur, this can be detected by the emerging of leaking water. To this extent, these leakage lines represent control lines. In contrast, they operate as relieving lines, because the exiting leaking water can flow off and does not enter into the interior of the rotary drive.

In order to achieve an optimal sealing effect, the seals are radially deformed such that they are firmly pressed against the assigned walls of the duct and against the sleeve. A reliable and durable sealing is therefore also ensured at high pressures.

For generating the radial contact pressure forces, pressure devices may be provided. For example, a pressure spring acts concentrically upon the seals, preferably by a washer, and press the seals against an abutment so that a corresponding radial deformation of the seals is achieved.

At higher pressures, the contact pressure upon the seal can be applied in the above-mentioned manner by the compressed water itself.

According to a broader idea of the invention, when the rotary drive is constructed as an electric drive, in the case of which the hollow shaft is fixedly connected with a rotor which rotates in a stator, the electric connection consists of a terminal box and of a watertight plug, while only a direct connection to the stator is known from the prior art. In this case, the stator is directly connected with the plug, the rear end of the plug acting as a terminal board. As a result, a sealing and finishing of the terminal box can be largely eliminated.

Furthermore, it may be provided in the case of an electric drive that the rotational speed of the hollow shaft is detected inductively, for example, by a proximity switch, which is placed at the appropriate point inside the housing.

This detection device may simultaneously be connected with a rotational speed controller by which an optimal rotational speed is kept constant. However, it is also conceivable to couple the detection device only with a signal generator which becomes active when the rotational speed falls below a defined desired rotational speed.

Other advantages and normal features the present invention will become apparent form the following detailed descriptions of the invention, when considered in conjunction with the drawings.

### BRIEF DESCRIPTIONS OF THE DRAWINGS

FIG. 1 is a longitudinal sectional view of a rotary drive for a hydraulic tool incorporating the principles of the present invention.

FIG. 2 is a longitudinal sectional view of another rotary drive for a hydraulic tool incorporating the principles of the present invention.

### DETAILED DESCRIPTION OF THE PREFERRED EMBODIMENTS

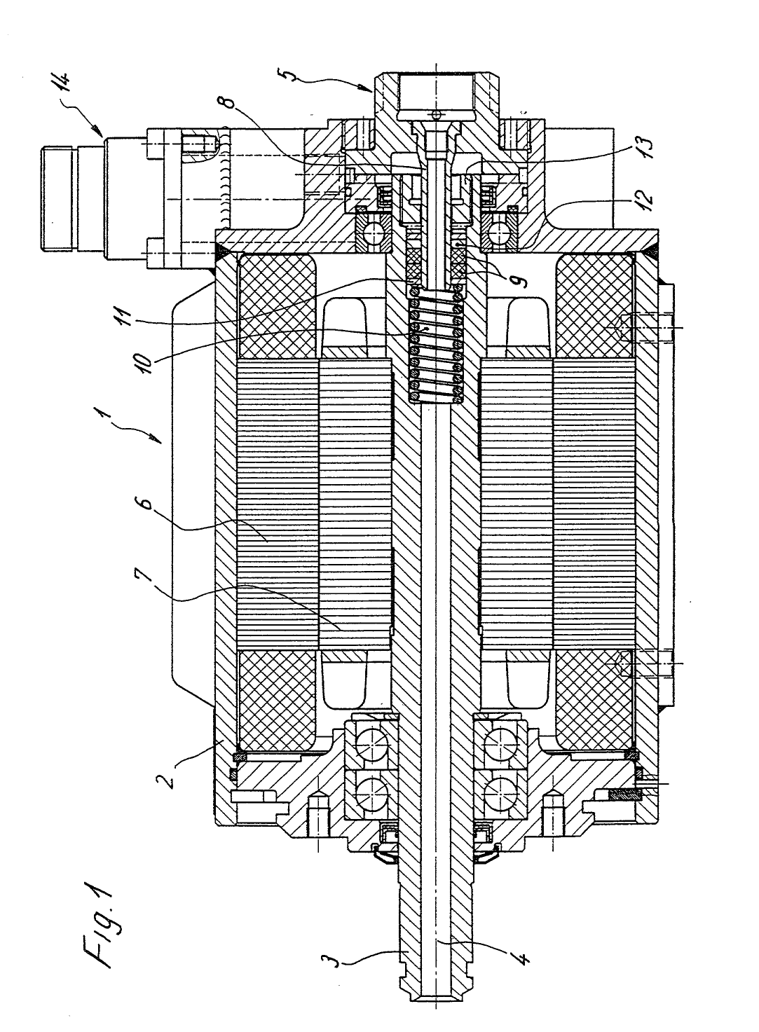

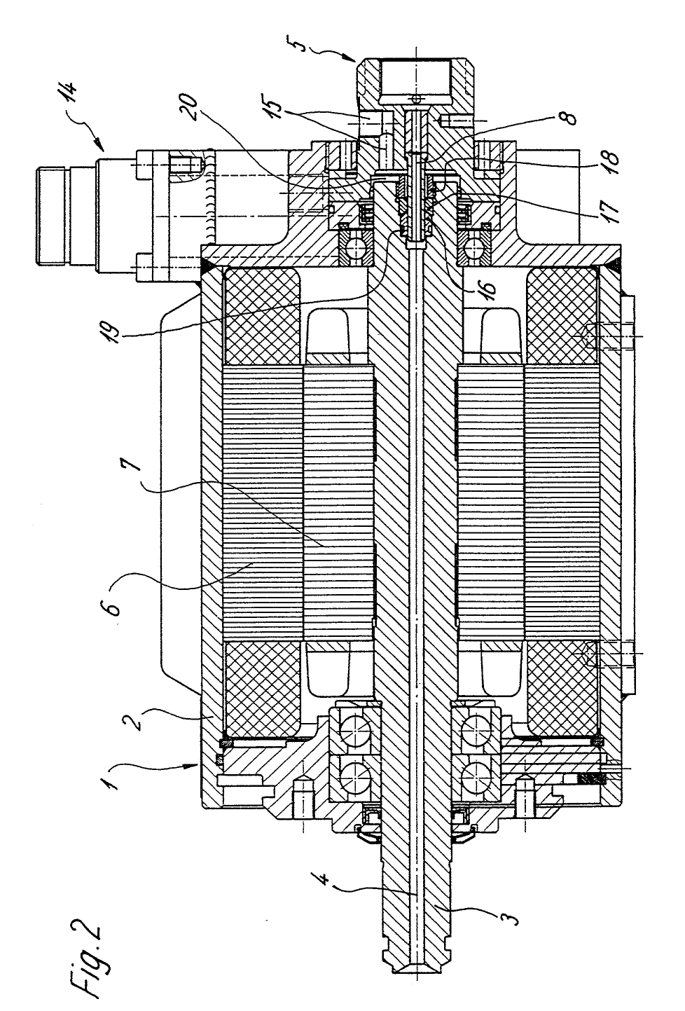

FIGS. 1 and 2 each show a rotary drive for a hydraulic tool which, as a whole, has the reference number 1. For reasons of clarity, identical components have the same reference numbers.

The rotary drive 1 has a largely closed housing 2 in which a stator 6 and a rotor 7 operatively connected thereto are arranged. The stator 6 is directly connected with a watertight plug coupling 14.

A hollow shaft 3 is arranged in a torsion-proof manner in the rotor 7. The hollow shaft 3 has a passage duct 4 which extends through the center and through which the compressed water can be guided. The is introduced via a hydraulic connection 5 fastened to the housing 2.

A nozzle carrier, which is not shown and which can be equipped with nozzles, is fastened to the hollow shaft 3 opposite the hydraulic connection 5. Instead of nozzles, other hydraulically operated tools can also be connected to shaft 3.

On the end of the hollow shaft 3 facing the hydraulic connection 5, a sleeve 8 projects into the duct 4 which is widened in this area.

Between the wall of the duct 4 and the surface area of the sleeve 8, separate ring seals 9, 16 are provided which sealingly rest against the respective wall and surface area.

In the embodiment illustrated in FIG. 1, two ring seals 9 are provided which rest against one another, have a square cross-section and, on both sides, rest on washers 11, 12.

In the area of the duct 4 following the sleeve 8, a pressure spring 10 is arranged which is supported, on the one side, at the base of the duct widening and, on the other side, on the washer 11.

A screw piece 13, which is screwed into the hollow shaft 3 on the face end, presses the seals 9 by way of the washer 12 against the pressure spring 10. The screw piece 13 forms an abutment with respect to the pressure spring 10. As a result of the pressure of the pressure spring 10 which acts axially upon the seals 9, these seals, which are a sealing-material-inherent deformability, on the one side, are pressed radially against the walls of the duct 5 and, on the other side, against those of the sleeve 8, so that an absolute tightness is ensured.

As a result of the occurring frictional engagement between the seals 9 and the sleeve 8, the sleeve 8, which is supported by its head having a collar in a recess of the hydraulic connection 5, is held in a secure manner.

In the embodiment illustrated in FIG. 2, which illustrates the rotary drive 1 suitable particularly for high pressures greater than 2,000 bar, the end of the ring seal 16 facing the hydraulic connection 5 is generally a cone ascending toward the center axis. The cone is supported on a correspondingly adapted face of an adjoining supporting ring 17. The opposite face of the supporting ring 17 rests against a screw piece 18 which is screwed from the end of the hollow shaft 3 into the duct 4.

Here also, the sleeve 8 is held in the hydraulic connection 5.

During the operation, thus when the compressed water flows by way of the hydraulic connection 5 into the duct 4, a pressure is exercised by the compressed water on the end of the ring seal 16 facing away from the cone. The pressure presses the ring seal 16 against the supporting ring 17, and the two mutually adjoining conical constructions act as a wedge and cause a pressing of the sealing ring 16, particularly against the wall of the sleeve 8.

The sealing effect with respect to the wall of the duct 4 is intensified by an O-ring 19 provided in the ring seal 16.

In the event of a leakage, leaking water flows out between the ring seal 16 and the sleeve or the wall of the duct 4 toward the end of the hollow shaft 3, where it flows into a chamber 20 to which a leakage opening 15 is connected and from which the leaking water can be discharged. In this case, the leakage opening 15 is used as a controlling or relieving opening by means of which it can be detected that leakage is present.

The two embodiments show that a very simple exchange of the ring seals 9, 16 can be implemented from the compressed-water inlet end, because only the hydraulic connection 5 and the sleeve 8 have to be removed for this purpose.

Although the present invention has been described and illustrated in detail, it is to be clearly understood that the same is by way of illustration of example, and is not to be taken by way of limitation. The spirit and the scope of the present invention are to be limited only by the terms the appended claims.

1. A rotary drive for a hydraulic tool, comprising:
a housing;
a hydraulic connection on the housing;
a rotatable hollow shaft in the housing, having an axially extending center passage duct and being connected with a nozzle carrier;
a sleeve inserted from a hydraulic connection end of the housing into the passage duct; and
a seal consisting of at least one separate ring seal which rests in a sealing manner on the wall of the passage duct and on the sleeve.

2. The rotary drive according to claim 1, wherein
the ring seal is pressed over it full surface onto the adjacaent walls of the duct and of the sleeve.

3. The rotary drive according to claim 2, wherein
the ring seal is pressured on one end face by a pressure spring guided in the duct and is supported on an opposite end face by on a screw piece directly or indirectly; and the screw piece is screwed into the hollow shaft.

4. The rotary drive according to claim 2, wherein
a face of the ring seal facing the hydraulic connection has an ascending conical construction toward the longitudinal center axis and is supported by this face on a supporting ring which corresponds to the conicality of the ring seal; and the supporting ring rest by its opposite face on a screw piece which is screwed into the hollow shaft.

5. The rotary drive according to claim 4, wherein a face side of the ring seal situated opposite the conical face side is in an operative connection with the compressed-water duct.

6. The rotary drive according to claim 1, including a stator directly connected with an electric plug coupling which is connected to the housing by a terminal box; and a rotor fixedly connected with the hollow shaft.

7. The rotary drive according to claim 1, wherein a proximity switch is fixed in the housing for measuring the rotational speed of the hollow shaft wherein.

8. The rotary drive according to claim 7, wherein the proximity switch is an induction switch.

9. The rotary drive according to claim 7, wherein
the proximity switch is connected with a rotational speed controller.
